(19) United States
(12) Patent Application Publication
(10) Pub. No.: US 2014/0234798 A1
(43) Pub. Date: Aug. 21, 2014

(54) Dental Screw Tip Elevators and Methods of Using the Same

(71) Applicant: DENTAL USA, INC., McHenry, IL (US)

(72) Inventor: Jang H. Lim, McHenry, IL (US)

(73) Assignee: DENTAL USA, INC., McHenry, IL (US)

(21) Appl. No.: 14/182,365

(22) Filed: Feb. 18, 2014

Related U.S. Application Data
(60) Provisional application No. 61/766,329, filed on Feb. 19, 2013.

(51) Int. Cl. A61C 3/14

(52) U.S. Cl. CPC A61C 3/14
USPC 433/141; 433/215

(57) ABSTRACT

A dental elevator apparatus used to easily and efficiently elevate a tooth or dental implant for removal thereof. Specifically, the dental elevator has a tip portion having a curved, helically-shaped contoured surface for engaging a tooth or dental implant, allowing the same to be utilized by a user, providing leverage against the tooth or dental implant for elevation of the same. Methods of using the same are further provided.

### CROSS-REFERENCE TO RELATED APPLICATIONS

This application claims the benefit of U.S. Provisional Patent Application Ser. No. 61/766,329 filed on Feb. 19, 2013.

### TECHNICAL FIELD OF THE INVENTION

The present invention relates to a dental elevator and methods of using the same. Specifically, the present invention provides a dental elevator apparatus for easily and efficiently elevating a tooth or dental implant for removal thereof. Methods of using the same are further provided.

### BACKGROUND OF THE INVENTION

It is, of course, generally known to utilize tools to elevate teeth and/or implants from a person's mouth. For example, pliers type devices have long been used to loosen or remove a tooth from a mouth. Through the years, improvements have been made in the configuration of dental tools for engaging the tooth and/or the surrounding tissue to make it more convenient or easier to loosen or remove a tooth or a portion of a tooth.

Conventional dental elevators tend to utilize a holder portion, a stem portion and a beak portion. Referred to, generally, as “T-shaped” due to the shape of the stem portion in relation to the handle portion, these elevators may be classified according to the shape of their beak portions. For example, beak portions may be known as straight beak, warped beak, bayonet beak and bent beak, to name a few. For example, U.S. Pat. No. 1,606,686 to Barry discloses a T-shaped implement having a handle grasped by the hand of the operator and a shank positioned to be engaged by the index finger of the operator's hand. However, this dental instrument does not generally provide an easy and efficient way of engaging a tooth or dental implant to leverage the same to elevate and/or remove the tooth or implant from the mouth.

In addition, U.S. Pat. No. 4,315,745 to Murata discloses a dental elevator comprising a holder portion, a stem portion, and a beak portion, the improvement being that the beak portion has an extremity formed in a shape selected from a U-shape, a V-shape, a zigzag shape and a serrated shape. The dental elevator extracts a tooth utilizing a lever action and a wedge action. However, due to the shape of a mouth and the relative lack of space within a mouth, it can be difficult to utilize a dental elevator such as disclosed in Murata to easily and efficiently elevate a tooth. The device of Murata must be configured to engage the root of a tooth which may not be easily accessible due to the tooth's relative position in the mouth. Moreover, it may be difficult, once engaged with the tooth, to provide significant leverage to remove the tooth or dental implant.

A need, therefore, exists for an improved dental elevator apparatus and methods of using the same for elevating a tooth or a dental implant. More specifically, a need exists for an improved dental elevator apparatus and methods of using the same that allow it to be easily gripped by a user for elevating a tooth or dental implant.

Moreover, a need exists for an improved dental elevator apparatus and methods of using the same that provides ease of use to engage a tooth or dental implant no matter the position of the tooth or dental implant within a mouth. In addition, a need exists for an improved dental elevator apparatus and methods of using the same that allows a user to easily be placed anywhere within a mouth to engage a tooth or dental implant.

Further, a need exists for an improved dental elevator apparatus and methods of using the same that allows a user to easily elevate and remove the tooth or dental implant using very little strength to do so. Still further, a need exists for an improved dental elevator apparatus and methods of using the same that provides significant leverage to a user to engage a tooth and/or dental implant to elevate and/or remove the tooth and/or dental implant.

### SUMMARY OF THE INVENTION

The present invention relates to a dental elevator and methods of using the same. Specifically, the present invention provides a dental elevator apparatus for easily and efficiently elevating a tooth or dental implant for removal thereof. Methods of using the same are further provided.

To this end, in an embodiment of the present invention, a dental apparatus is provided. The dental apparatus comprises a handle; a shaft connected to the handle; and a tip connected to the shaft. The tip preferably comprises a relatively flattened portion having an internal surface and an external surface, a first side edge and a second side edge, and a tip portion, wherein the first side edge and second side edge are arranged helically and longitudinally around an imaginary axis so that the internal surface faces toward the imaginary axis.

In an embodiment, the first side edge is sharpened.

In an embodiment, the second side edge is sharpened.

In an embodiment, both the first and second side edges are sharpened.

In an embodiment, the first side edge and the second side edge converge to form a tip point.

In an embodiment, the tip point is sharpened.

In an embodiment, the shaft extends straight from the handle to the tip.

In an embodiment, the shaft is bent at a point between the handle and the tip, so that the tip extends angularly relative to the handle.

In an embodiment, the shaft further comprises a first portion extending from the handle, and a second portion extending at a first angle from the first portion, and the tip extending at a second angle from the second portion.

In an embodiment, the first angle is about forty-five degrees.

In an embodiment, the second angle is about ninety degrees.

In an embodiment, the first angle is about forty-five degrees and the second angle is about ninety degrees.

Embodiments of a method of using a dental apparatus is also provided. Generally speaking, the method comprises the steps of: providing a dental apparatus comprising a handle, a shaft connected to the handle, and a tip connected to the shaft, the tip comprising a relatively flattened portion having an internal surface and an external surface, a first side edge and a second side edge, and a tip portion, wherein the first side edge and second side edge are arranged helically and longitudinally around an imaginary axis so that the internal surface faces toward the imaginary axis; placing the dental apparatus adjacent a tooth or dental implant; and pushing the dental apparatus subgingivally to elevate the tooth or dental implant.

In an embodiment, the first and second side edges of the tip of the dental apparatus are sharpened.

In an embodiment, the first side edge and the second side edge converge at a tip point.

In an embodiment, the tip point is sharpened.

In an embodiment, the shaft is straight from the handle to the tip.

In an embodiment, the shaft is bent at a point between the handle and the tip, so that the tip extends angularly relative to the handle.

In an embodiment, the shaft further comprises a first portion extending from the handle, and a second portion extending at a first angle from the first portion, and the tip extending at a second angle from the second portion.

In an embodiment, the first angle is about forty-five degrees and the second angle is about ninety degrees.

It is, therefore, an advantage and objective of the present invention to provide an improved dental elevator apparatus and methods of using the same for elevating a tooth or a dental implant.

More specifically, it is an advantage and objective of the present invention to provide an improved dental elevator apparatus and methods of using the same that allows the same to be easily gripped by a user thereof for elevating a tooth or dental implant.

Moreover, it is an advantage and objective of the present invention to provide an improved dental elevator apparatus and methods of using the same that is easy to use to engage a tooth or dental implant no matter the position of the tooth or dental implant within a mouth.

In addition, it is an advantage and objective of the present invention to provide improved dental elevator apparatus and methods of using the same that allows a user to easily place the tool anywhere within a mouth to engage a tooth or dental implant.

Further, it is an advantage and objective of the present invention to provide an improved dental elevator apparatus and methods of using the same that allows a user to easily elevate and remove the tooth or dental implant using relatively little force.

Still further, it is an advantage and objective of the present invention to provide an improved dental elevator apparatus and methods of using the same that provides significant leverage to a user to engage a tooth and/or dental implant to elevate and/or remove the tooth and/or dental implant.

Additional features and advantages of the present invention are described in, and will be apparent from the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a plan view of a dental elevator with a straight shaft and a helical tip in an embodiment of the present invention.

FIG. 2 illustrates a close-up view of a helical tip of a dental elevator in an embodiment of the present invention.

FIG. 3 illustrates a close-up mirror image view of a helical tip of a dental elevator in an embodiment of the present invention.

FIG. 4 illustrates a plan view of a dental elevator with a bent shaft and a helical tip in an embodiment of the present invention.

FIG. 5 illustrates a close-up view of a helical tip of a dental elevator with a bent shaft in an embodiment of the present invention.

FIG. 6 illustrates a dental elevator used in a patient's mouth to elevate and remove a tooth or dental implant.

### DETAILED DESCRIPTION OF THE INVENTION

The present invention relates to a dental elevator and methods of using the same. Specifically, the present invention provides a dental elevator apparatus for easily and efficiently elevating a tooth or dental implant for removal thereof. Methods of using the same are further provided.

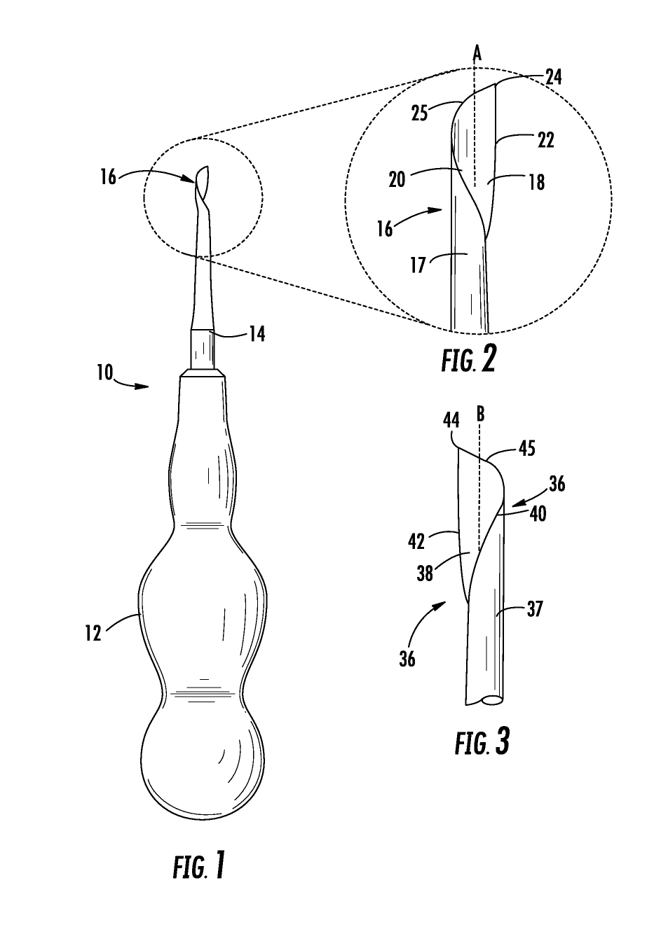

Now referring to the figures, wherein like numerals refer to like parts, FIG. 1 illustrates a dental elevator 10 in an embodiment of the present invention. The dental elevator may have a handle 12 and a shaft 14 extending from the handle 12. In the embodiment illustrated in FIG. 1, the shaft is relatively straight, although the invention should not be limited in this manner. Specifically, shafts may have other shapes as well. FIG. 4 illustrates an alternate embodiment of the present invention of a dental elevator 100 having a bent shaft 104, described in more detail below.

The handle 12 of the dental elevator 10 may be utilized for a user to grip the dental elevator 10 and use the same to elevate and remove a tooth or dental implant, as disclosed herein. The shape or design of the handle 12 is not important to the proper functioning of the dental elevator and its use in elevating and removing teeth or dental implants, and the invention should not be limited as described or shown herein. The handle 12 may be made of any material apparent to one of ordinary skill in the art, preferably metal, thermoplastic or other like material.

The shaft 14 may extend from the handle 12 and may be made from a material useful to ensure that the shaft 14 has sufficient strength to operate, in conjunction with tip 16, to elevate and remove a tooth or a dental implant. Thus, the shaft 14 may preferably be made of metal, or other strong and resilient material, including, for example, plastic, or other like material. A user of the dental elevator 10 may place significant stress on the shaft 14 of the dental elevator 10 when used to elevate and remove a tooth or dental implant, and must have sufficient strength to withstand the stress placed thereon.

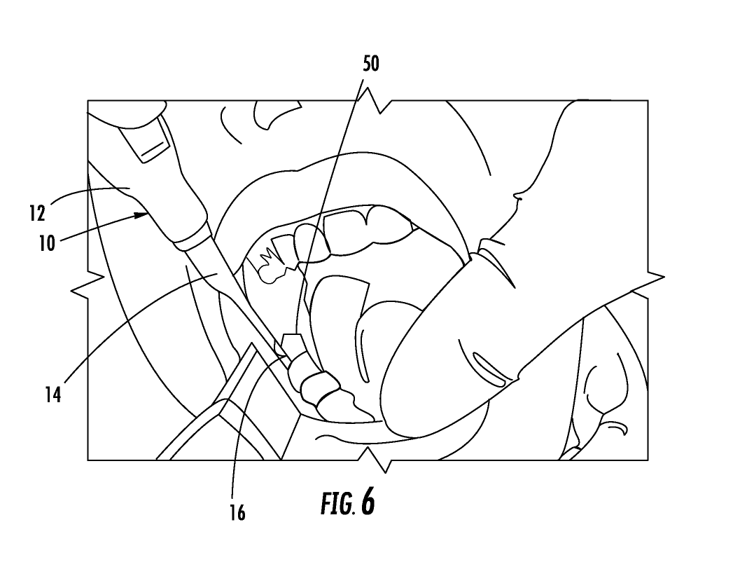

The tip 16 of the shaft 14 may be specially shaped to aid in the loosening and subsequent removal of a tooth or dental implant. Specifically, as illustrated in FIG. 2, a close-up view of the tip 16 of the dental elevator 10, the tip 16 may be shown as having a relatively flattened portion that has a generally curved internal surface contour. Preferably, the tip 16 may have a first edge 20, a second edge 22, an external surface 17, and an internal surface 18 that may be configured helically around an imaginary central axis (A) running longitudinally to the shaft 14. The first edge 20 and second edge 22 may be configured to be relatively sharp so as to aid in inserting the tip 16 subgingivally adjacent a tooth or dental implant for elevating the tooth or dental implant, as illustrated in FIG. 6, and described in more detail below.

The first edge 20 and second edge 22 of the tip 16 may converge at tip point 24, forming cutting edge 25. Tip point 24 may also be relatively sharp so as to aid in inserting the tip 16 subgingivally adjacent a tooth or dental implant.

As with all helices, the helically arranged tip 16 may have a chirality which may aid in its use to elevate and remove a tooth or dental implant. As illustrated in FIG. 2, the helically arranged tip 16 may have a left-handed or sinister chirality, which may be useful for elevating teeth or dental implants on a particular side of the mouth, or on a particular side of a tooth, whether on the lingual side or the facial side of the tooth.

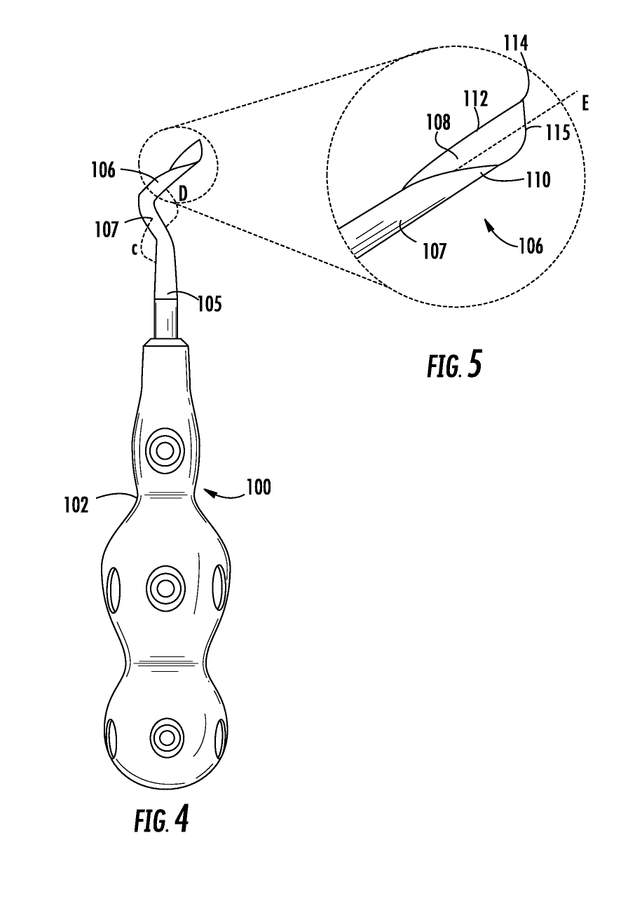

FIG. 3 illustrates another example of a tip 36 having an external surface 37, an internal surface 38, a first edge 40 and a second edge 42, helically arranged around an imaginary axis (B), running longitudinally to a shaft (not shown) attached thereto. However, as opposed to the left-handed chirality of the tip 16, as illustrated in FIG. 2, the tip 36 may be helically arranged with right-handed, or dexter, chirality, which may be useful for elevating teeth or dental implants on an opposite side of the mouth, or on an opposite side of a tooth, whether on the lingual side or the facial side of the tooth, compared to the left-handed or sinister chirality of the tip 16, described above.

Now referring to FIG. 4, an alternate embodiment of a dental elevator 100 is shown and disclosed herein. The dental elevator 100 may have a handle 102, a shaft 104 and a tip 106, in similarity to the dental elevator 10, described above with reference to FIG. 1. However, the shaft 104 of the dental elevator 100 may have a bent configuration. Specifically, the shaft 104 may have a portion 105 that extends from handle 102, the shaft 104 further including portion 107 extending at an angle (C) from portion 105, and tip 106 extending at an angle (D) from portion 107. Preferably, angle (C) may be roughly about forty-five degrees (45°) and angle (D) may be roughly about ninety degrees (90°). Bent shaft 104 may be useful to allow a user of the dental apparatus 100 to reach hard-to-reach areas of the mouth to aid in elevating and removing a tooth or dental implant.

As illustrated in FIG. 5, the tip 106 is shown in close-up. The tip may have an external surface 107, an internal surface 108, a first edge 110, a second edge 112, and a tip point 114 arranged helically around imaginary axis (E), roughly similar to or the same as the tip 36 illustrated in FIG. 3, with right-handed, or dexter, chirality. Of course, the dental apparatus 100 may further have a tip having left-handed, or sinister, chirality, as described above with reference to FIG. 2, depending on the particular location of the tooth or dental implant, and the particular side of the tooth the dental apparatus 100 is used, either lingually or facially. However, due to the bent nature of the shaft 104, the tip 106 may be arranged at an angle relative to the portion 105 and/or handle 102 of the dental apparatus 100.

As illustrated in FIG. 6, dental elevator 10 is illustrated, specifically having straight shaft 14, in a patient's mouth to loosen and elevate a tooth 50. As illustrated a user may grip the handle 12 of the dental elevator 10 and work the tip 16 subgingivally adjacent the tooth 50. The helically-arranged sharpened edges 20, 22 may be utilized to aid in pushing the tip 16 subgingivally adjacent the tooth so that the tip point 24 and surface contour 18 may be wrapped, generally, around a root of the tooth. Thus, the user may be provided sufficient leverage to pry the tooth 50 upwardly, thereby removing the same. To aid the user in moving the tip 16 subgingivally, the user may rock the dental elevator 10 back and forth and/or slightly twist the dental elevator around imaginary axis (A) (see FIG. 2), the helically-arranged edges 20, 22 moving deeper adjacent the tooth 50 to provide the user sufficient leverage to elevate the tooth 50.

It should be noted that various changes and modifications to the presently preferred embodiments described herein will be apparent to those skilled in the art. Such changes and modifications may be made without departing from the spirit and scope of the present invention and without diminishing its attendant advantages.

What is claimed is:

1. A dental apparatus comprising:
a handle;
a shaft connected to the handle; and
a tip connected to the shaft, the tip comprising:
a relatively flattened portion having an internal surface and an external surface,
a first side edge and a second side edge, each edge being adjacent the internal and external surfaces, and
a tip portion formed at a convergence of the first side edge and the second side edge,
wherein the first side edge and second side edge are arranged helically around a longitudinal axis of the tip so that the internal surface faces the axis.

2. The dental apparatus of claim 1, wherein the first side edge is sharpened.

3. The dental apparatus of claim 1, wherein the second side edge is sharpened.

4. The dental apparatus of claim 1, wherein the first and second side edges are sharpened.

5. The dental apparatus of claim 1, wherein the first side edge and the second side edge converge completely to form a tip point.

6. The dental apparatus of claim 5, wherein the tip point is sharpened.

7. The dental apparatus of claim 1, wherein the shaft is straight between the handle and the tip.

8. The dental apparatus of claim 1, wherein the shaft comprises at least one bend at a point between the handle and the tip, such that the tip extends angularly relative to the handle.

9. The dental apparatus of claim 1, wherein the shaft comprises a first portion extending from the handle, and a second portion extending at a first angle from the first portion, and the tip extends at a second angle from the second portion.

10. The dental apparatus of claim 9, wherein the first angle is about forty-five degrees.

11. The dental apparatus of claim 9, wherein the second angle is about ninety degrees.

12. The dental apparatus of claim 9, wherein the first angle is about forty-five degrees and the second angle is about ninety degrees.

13. A method of using a dental apparatus comprising the steps of:
providing a dental apparatus comprising a handle, a shaft connected to the handle, and a tip connected to the shaft, the tip comprising a relatively flattened portion having an internal surface and an external surface, a first side edge and a second side edge, and a tip portion, wherein the first side edge and second side edge are arranged helically about a longitudinal axis of the tip such that the internal surface faces the axis;
placing the dental apparatus adjacent a tooth or dental implant; and
pushing the dental apparatus subgingivally to elevate the tooth or dental implant.

14. The method of claim 13, wherein the step of pushing the dental apparatus subgingivally comprises the step of pushing the tip subgingivally adjacent a tooth so that a tip point formed by the convergence of the first and second side edges and the internal surface engage a root of the tooth.

15. The method of claim 14, further comprising the step of prying the tooth upwardly from the engaged root.

16. The method of claim 15, further comprising the step of moving the tip subgingivally while engaged with the root.

17. The method of claim 15, wherein the step of moving the tip comprises the step of rocking the dental apparatus back and forth.

18. The method of claim 15, wherein the step of moving the tip comprises the step of slightly twisting the dental apparatus about the longitudinal tip axis.

19. The method of claim 15, wherein the step of moving the tip comprises the step of moving the first and second side edges deeper adjacent the tooth to provide the user sufficient leverage to elevate the tooth.
